(19) United States
(12) Patent Application Publication
(10) Pub. No.: US 2012/0013792 A1
(43) Pub. Date: Jan. 19, 2012

(54) ELECTRONIC DEVICE

(75) Inventors: Seiya Shibata, Osaka (JP); Takashi Asano, Osaka (JP)

(73) Assignee: SANYOELECTRIC CO., LTD., Osaka (JP)

(21) Appl. No.: 13/181,919

(22) Filed: Jul. 13, 2011

(30) Foreign Application Priority Data
Jul. 14, 2010 (JP) 2010-159493

(51) Int. Cl. H04N 5/225

(52) U.S. Cl. 348/376; 348/E05.024

(57) ABSTRACT

An electronic device in which a sliding member and a guide trench that regulates the moving path are formed in a device body, comprising the device body, wherein a slide member that slides along the surface of the device body is connected to the device body, the sliding member can be moved between a closed position where a predetermined area of a surface of the device body is covered, and an opened position where the predetermined area is exposed, a guide trench that regulates the moving path of the sliding member is concavely formed in the device body, and a sliding portion that is slidingly fitted in the guide trench is formed in the sliding member. In this case, between the sliding portion and the guide trench, an inerposed member having a friction coefficient smaller than that of the sliding portion with respect to the guide trench is interposed, and an engagement mechanism that engages the sliding portion and the interposing member with each other is arranged on the sliding portion and the interposing member.

Japanese Patent Application No. 2010-159493 filed on Jul. 14, 2010 and serving as a base of priority claims of the present application is included in the disclosure by citation.

### TECHNICAL FIELD OF THE INVENTION

The present invention relates to an electronic device including a sliding member that slides along a surface of a device body.

### BACKGROUND ART

In an electronic device of this type, the sliding member can be moved between a closed position where a predetermined area of the surface of the device body is covered, and an opened position where the predetermined area is exposed. A guide trench that regulates the moving path of the sliding member is concavely formed in the device body, and a sliding portion that is slidingly fitted in the guide trench is formed in the sliding member.

In the electronic device, for example, the sliding member is made of a metal such as aluminum, and the guide trench is formed by a resin portion constituting an underbody or the like for the device body. Therefore, with the sliding operation of the sliding member, the side surfaces of the guide trench are easily worn out such that the side surfaces of the guide trench are shaved by a metal edge in the sliding portion.

In order to prevent the side surfaces of the guide trench, in the electronic device, the following configuration is conceived. That is, a resin member serving as a member having a small friction coefficient with respect to the guide trench maybe interposed between the sliding portion and the guide trench, and the resin member is adhesively fixed to the sliding portion.

### SUMMARY OF THE INVENTION

An electronic device according to the present invention includes a device body, a sliding member that slides along the surface of the device body is connected to the device body, the sliding member can be reciprocated between a closed position where a predetermined area of a surface of the device body is covered and an opened position where the predetermined area is exposed, a guide trench that regulates the moving path of the slide member is concavely formed in the device body, and a sliding portion that is slidingly fitted in the guide trench is formed in the sliding member. In this case, between the sliding portion and the guide trench, an interposing member having a friction coefficient smaller than that of the sliding portion with respect to the guide trench is interposed, and an engagement mechanism that engages the sliding portion and the interposing member with each other is arranged between the sliding portion and the interposing member.

### BRIEF DESCRIPTION OF THE DRAWINGS

FIG. 1 is a perspective view showing a digital camera according to an embodiment of the present invention when viewed from the front surface side of the digital camera.

FIG. 2 is a perspective view showing the digital camera when viewed from the rear surface side.

FIG. 3 is a perspective view used in the explanation of the closed position of the sliding member included in the digital camera.

FIG. 4 is a perspective view showing a first guide trench concavely formed in the device body of the digital camera.

FIG. 5 is a sectional view along an A-A line shown in FIG. 1.

FIG. 6 is an enlarged view of a B area shown in FIG. 5.

FIG. 7 is an enlarged view of a C area shown in FIG. 5.

FIG. 8 is a perspective view of the sliding member when viewed from the rear surface side.

FIG. 9 is an enlarged view of a D area shown in FIG. 8.

FIG. 10 is an exploded perspective view of a first sliding portion and a first resin member shown in FIG. 9.

FIG. 11 is an enlarged view of an E area shown in FIG. 10.

FIG. 12 is a perspective view of the device body of the digital camera from which a rear-surface-side half case is removed when viewed from the rear surface side of the device body.

FIG. 13 is an exploded perspective view of a second sliding portion and a second resin member shown in FIG. 12.

### DETAILED DESCRIPTION OF PREFERRED EMBODIMENTS

Each form in which the present invention is applied to a digital camera will be described below in detail with reference to the accompanying drawings.

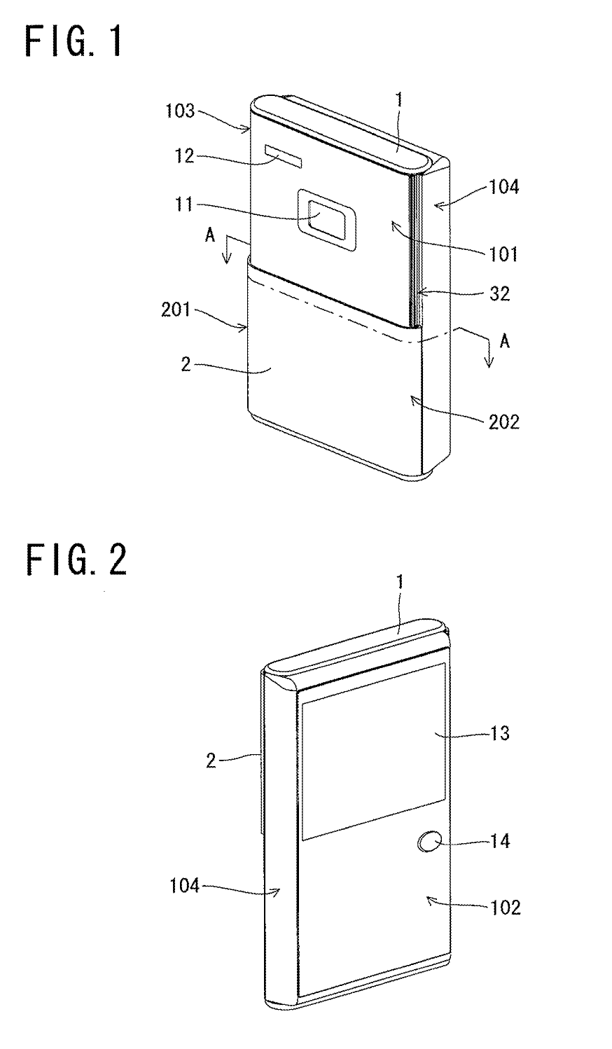

FIG. 1 is a perspective view showing a digital camera according to an embodiment of the present invention when viewed from the front surface side, and FIG. 2 is a perspective view showing the digital camera when viewed from the rear surface side. As shown in FIG. 1, the digital camera according to the embodiment includes a device body 1 extending lengthways in a vertical direction, and an optical lens 11 and a flash lamp 12 are arranged in the upper area of the front surface 101 of the device body 1. As shown in FIG. 2, on the rear surface 102 of the device body 1, a liquid crystal display panel 13 is arranged in the upper area. On the other hand, an operation button 14 is arranged in a lower area of the rear surface 102.

As shown in FIG. 1, a sliding member 2 that vertically slides along the front surface 101 is connected to the device body 1. In this case, the sliding member 2 is configured by a metal plate having a small thickness and has a shape along the front surface 101 of the device body 1. The sliding member 2 has both left and right end portions 201 and 202 go around on the left side surface 103 and the right side surface 104 of the device body 1, respectively.

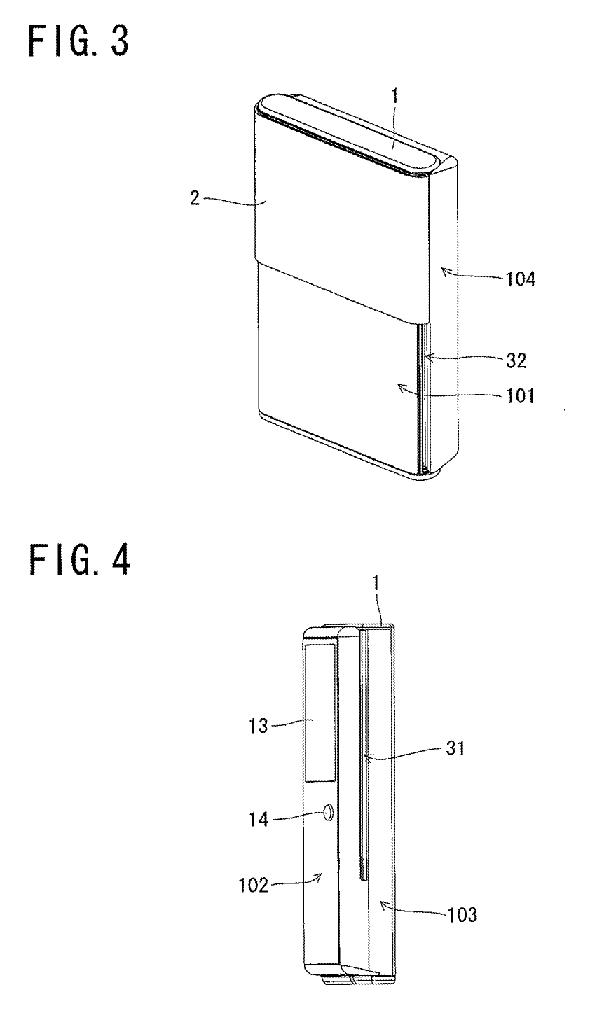

The sliding member 2 can be moved between a closed position where, as shown in FIG. 3, the upper area of the front surface 101 of the device body 1 is covered and an opened position where, as shown in FIG. 1, the upper area is exposed. When the slide member 2 is set to the closed position, as shown in FIG. 3, the optical lens 11 is hidden in the rear surface side of the sliding member 2. On the other hand, when the sliding member 2 is set to the opened position, as shown in FIG. 1, the optical lens 11 appears on the front surface 101 of the device body 1.

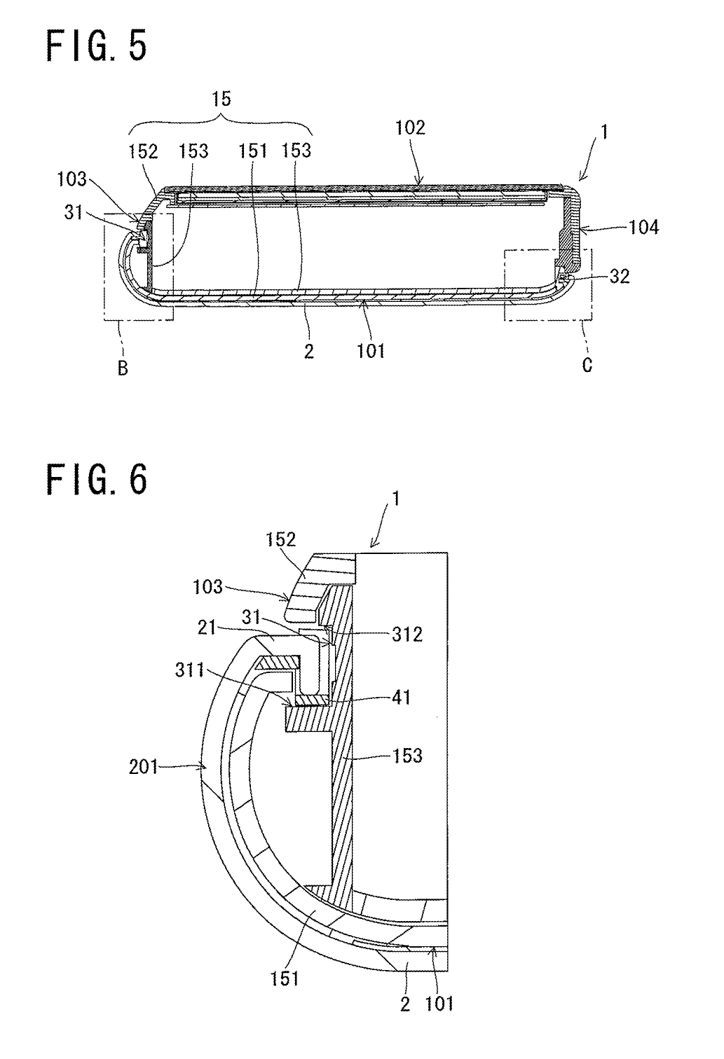

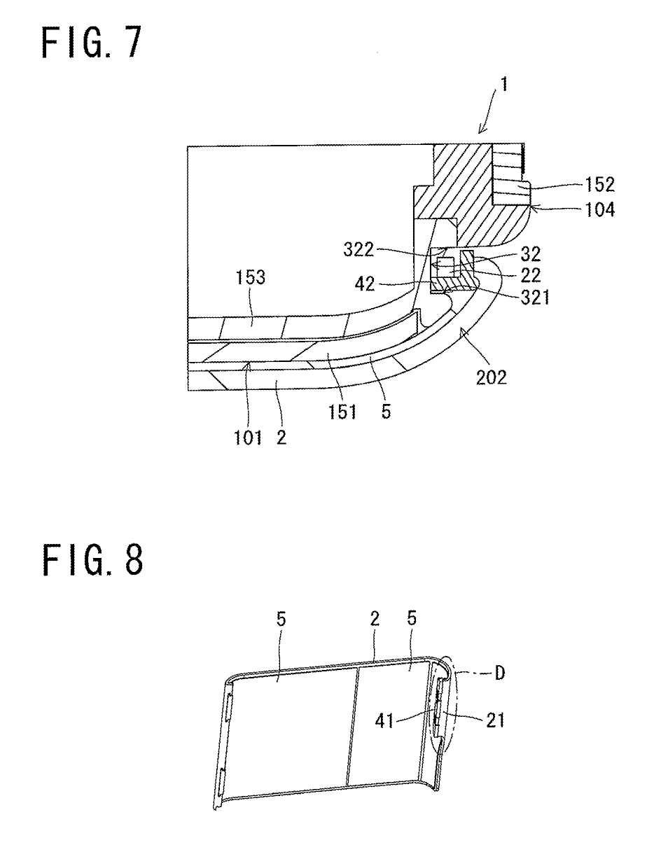

FIG. 5 is a sectional view along an A-A line shown in FIG. 1. FIGS. 6 and 7 are enlarged views of a B area and a C area shown in FIG. 5. As shown in FIGS. 5 to 7, in the device body 1, on the left side surface 103 and the right side surface 104, a first guide trench 31 and a second guide trench 32 that regulate moving paths of the sliding member 2 are concavely formed. More specifically, the first guide trench 31, as shown in FIG. 4, vertically extends along the left side surface 103 of the device body 1. On the other hand, the second guide trench 32, as shown in FIGS. 1 and 3, vertically extends along the right side surface 104 of the device body 1.

As shown in FIG. 5, a case 15 that forms an outer peripheral surface of the device body 1 is configured such that a metal front-surface-side half case 151 and a resin rear-surface-side half case 152 are attached to a resin underbody 153. As shown in FIGS. 6 and 7, the resin underbody 153 is partially exposed on the left side surface 103 and the right side surface 104 of the device body 1, and the first guide trench 31 and the second guide trench 32 are formed in the exposed portions of the underbody 153, respectively.

On the other hand, on the sliding member 2, a first sliding portion 21 is slidingly fitted in the first guide trench 31 by a bending deformation of the left end portion 201. Furthermore, on the slide member 2, a second sliding portion 22 that is slidingly fitted in the second guide trench 32 by a bending deformation of the right end portion 202 of the sliding member 2.

As shown in FIG. 6, in the front and rear side surfaces 311 and 312 that form the first guide trench 31, between the front side surface 311 and the first sliding portion 21, a first resin member 41 made of a resin is interposed. An engaging mechanism that engages the first sliding portion 21 and the first resin member 41 with each other is arranged on the first sliding portion 21 and the first resin member 41. In this case, the first resin member 41 is a member that has a friction coefficient smaller than that of the first sliding portion 21 when the first resin member 41 is brought into contact with the front side surface 311 of the first guide trench 31.

As shown in FIG. 7, in the front and rear side surfaces 321 and 322 that form the second guide trench 32, between the front side surface 321 and the second sliding portion 22, a second resin member 42 made of a resin is interposed. An engaging mechanism that engages the second sliding portion 22 and the second resin member 42 with each other is arranged on the second sliding portion 22 and the second resin member 42. In this case, the second resin member 42 is a member that has a friction coefficient smaller than that of the second sliding portion 22 when the second resin member 42 is brought into contact with the front side surface 321 of the second guide trench 32.

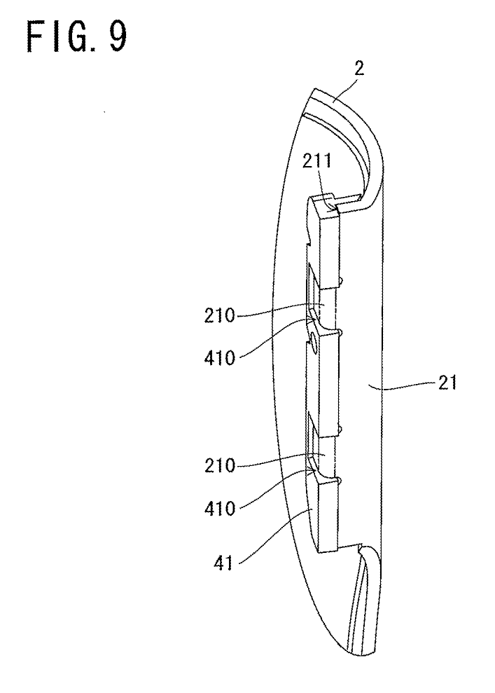

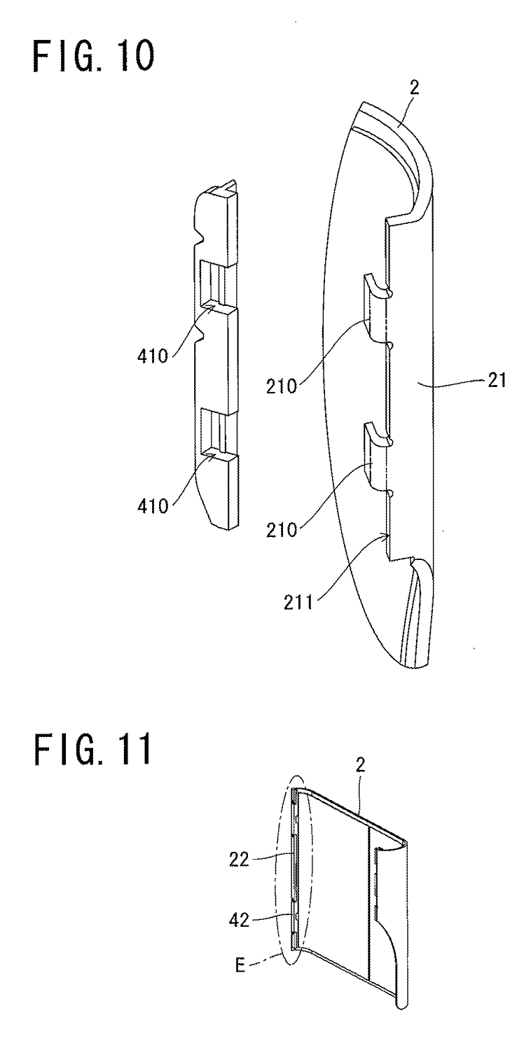

FIG. 8 is a perspective view of the sliding member 2 when viewed from the rear surface side. FIG. 9 is an enlarged view of the D area shown in FIG. 8, and FIG. 10 is an exploded perspective view of the first sliding portion 21 and the first resin member 41 shown in FIG. 9. As shown in FIGS. 9 and 10, one pair of engagement portions 210 are projected from the first sliding portion 21. On the other hand, an engaged portion 410 with which each of the engagement portions 210 of the first sliding portion 21 are engaged is concavely formed in the first resin member 41. Therefore, each of the engagement portions 210 of the first sliding portion 21 is engaged with the engaged portion 410 of the corresponding first resin member 41 to prevent the first resin member 41 from shifting from a predetermined position in the first sliding portion 21 in a direction along the first guide trench 31. Each of the engagement portions 210 of the first sliding portion 21 is formed by a bending deformation of the tongue part formed at a distal end 211 of the first sliding portion 21 in an L shape.

As shown in FIG. 9, the resin member 41 has a shape in which a part of the first resin member 41 is brought into contact with the distal end 211 of the first sliding portion 21 when the first resin member 41 is engaged with the first sliding portion 21. Therefore, each of the engagement portions 210 of the first sliding portion 21 is engaged with the engaged portion 410 of the corresponding first resin member 41 to bring the first resin member 41 into contact with the distal end 211 of the first sliding portion 21. In this manner, in a direction that is almost vertical to a direction along the first guide trench 31 and in which the first sliding portion extends from the bottom surface of the first guide trench 31, such that the resin member 41 is prevented from shifting from a predetermined position in the first sliding portion 21.

In this manner, each of the engagement portions 210 of the first sliding portion 21 and the engaged portion 410 of the first resin member 41 engaged with the engagement portions 210 configure an engagement mechanism that engages the first sliding portion 21 and the first resin member 41 with each other.

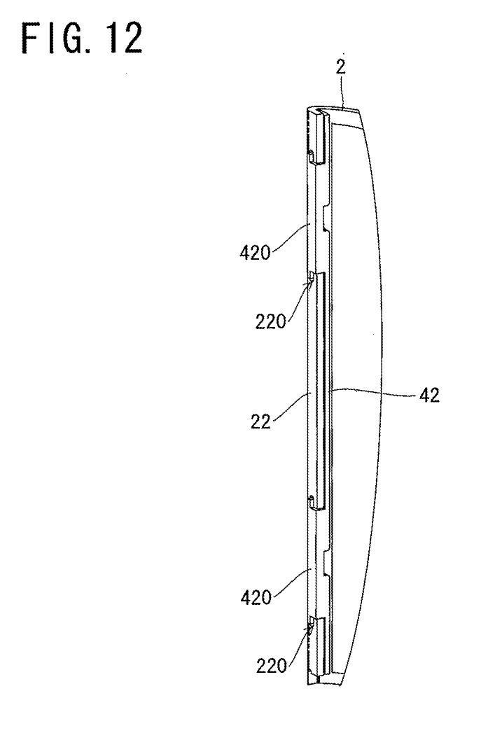

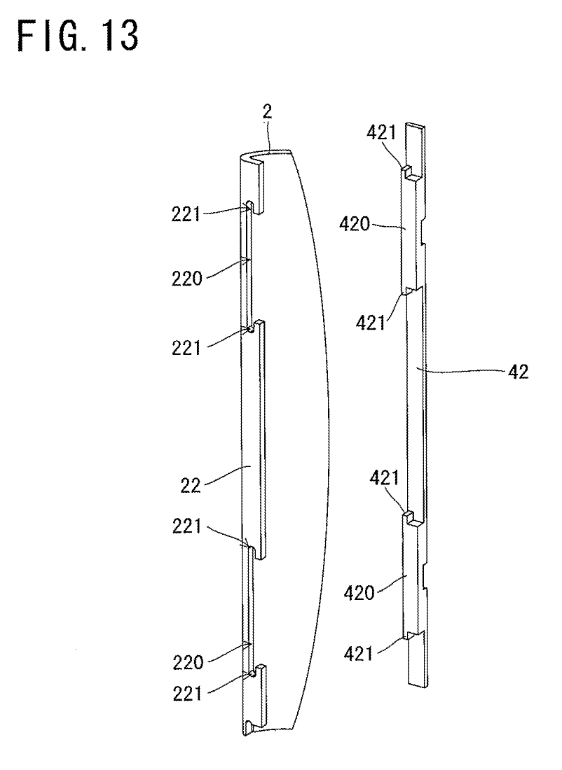

FIG. 11 is a perspective view of the sliding member 2 when viewed from a rear surface side at an angle different from that in FIG. 8. FIG. 12 is an enlarged view of the E area shown in FIG. 11, and FIG. 13 is an exploded perspective view of the second sliding portion 22 and the second resin member 42 shown in FIG. 12. As shown in FIGS. 12 and 13, one pair of engagement portions 420 are projected from the second sliding portion 42. On the other hand, an engaged portion 220 with which each of the engagement portions 420 of the second resin member 42 is engaged is concavely formed in the second sliding portion 22. Therefore, each of the engagement portions 420 of the second resin member 42 is engaged with the engaged portion 220 of the corresponding second sliding portion 22 to prevent the second resin member 42 from shifting from a predetermined position in the second sliding portion 22 in a direction along the second guide trench 32.

As shown in FIG. 13, projections 421 are formed on both upper and lower end faces of each of the engagement portions 420 of the second resin member 42, respectively. On the other hand, in the inner surface of the engaged portion 220 of the second sliding portion 22 corresponding to the engagement portions 420, a recessed portion 221 in which each of the projections 421 is to be fitted when the engagement portions 420 and the engaged portion 220 are engaged with each other, is formed. Therefore, each of the engagement portions 420 of the second sliding portion 42 is engaged with the engaged portion 220 of the corresponding second resin member 22 to fit each of the projections 421 in the corresponding recessed portion 221. In this manner, in a direction that is almost vertical to a direction along the second guide trench 32 and in which the second sliding portion extends from the bottom surface of the second guide trench 32, the second resin member 42 is prevented from shifting from a predetermined position in the second sliding portion 22.

In this manner, each of the engagement portions 420 of the second sliding portion 42 and the engaged portion 220 of the second sliding portion 22 engaged with the engagement portions 420 configure an engagement mechanism that engages the second sliding portion 22 and the second resin member 42 with each other.

In the digital camera, in the rear surface of the slide member 2, as shown in FIG. 8, a sliding sheet 5 that is to be interposed between the rear surface and the front surface 101 of the device body 1 is adhesively fixed in an assembled state. Therefore, when the sliding member 2 slides between the closed position and the opened position, the sliding sheet 5 slides on the front surface 101 in a state in which the sliding sheet 5 is interposed between the rear surface of the sliding member 2 and the front surface 101 of the device body 1. For this reason, the rear surface of the sliding member 2 is not in contact with the front surface 101 of the device body 1, and, therefore, the front surface 101 of the device body 1 is difficult to be worn out.

According to the configuration, the first sliding portion 21 gets closed to the front side surface 311 of the first guide trench 31 by the thickness of the sliding sheet 5, and the second sliding portion 22 gets close to the front side surface 321 of the second guide trench 32. Therefore, a part of the first resin member 41 is caught between the first sliding portion 21 and the front side surface 311 of the first guide trench 31, and a part of the second resin member 42 is caught between the second sliding portion 22 and the front side surface 321 of the second guide trench 32. In this manner, engagement between the first sliding portion 21 and the first resin member 41 and engagement between the second sliding portion 22 and the second resin member 42 are not easily canceled in an assembled state.

In the digital camera, the first resin member 41 prevents the first sliding portion 21 from being in contact with the front side surface 311 of the first guide trench 31. The first resin member 41 is brought into contact with the front side surface 311 of the first guide trench 31. Therefore, the side surface 311 of the first guide trench 31 is difficult to be worn out in comparison with a case in which the metal first sliding portion 21 is in contact with a side surface 311.

In this case, the first sliding portion 21 and the first resin member 41 are engaged with each other by an engagement mechanism. The engagement is not easily canceled in an assembling state. In this manner, the first resin member 41 does not shift from the predetermined position on the first sliding portion 21. Therefore, even though the sliding member 2 slides, the first resin member 41 is reliably fixed to a predetermined position on the first sliding portion 21. For this reason, according to the digital camera, wearing of the front side surface 311 of the first guide trench 31 is reliably reduced.

For the same reason as described above, wearing of the front side surface 321 of the second guide trench 32 is reliably reduced by the second resin member 42.

In the digital camera, between the first sliding portion 21 and the first resin member 41 and between the second sliding portion 22 and the second resin member 42, adhesive members such as an adhesive agent or an adhesive tape need not be interposed. Therefore, in comparison with a conventional electronic device, the thicknesses of the first guide trench 31 and the second guide trench 32 can be reduced by the thicknesses of the adhesive members. Therefore, according to the digital camera, the device body 1 can be reduced in size, and the first guide trench 31 and the second guide trench 32 are obscured by the front surface of the device body 1.

Furthermore, in an assembling step of the digital camera, before the first sliding portion 21 is fitted in the first guide trench 31, the first resin member 41 need only to be engaged with the first sliding portion 21. Furthermore, before the second sliding portion 22 is fitted in the second guide trench 32, the second resin member 42 need only to be engaged with the second sliding portion 22. Therefore, unlike any conventional electronic device, a complex operation to adhesively fix a resin member to a sliding portion is not required. Therefore, according to the digital camera, the workability of the assembling operation is improved.

The configurations of the portions of the present invention are not limited to this embodiment, and the configurations can be variously changed without departing from the technical essence and scope of the invention. For example, a part of the first resin member 41 may be interposed between the first sliding portion 21 and the bottom surface of the first guide trench 31 and/or the rear side surface 312. In this manner, the first sliding portion 21 is also prevented from being in contact with the bottom surface of the first guide trench 31 and/or the rear side surface 312 by the first resin member 41. Similarly, a part of the second resin member 42 may be interposed between the second sliding portion 22 and the bottom surface of the second guide trench 32 and/or the rear side surface 322. In this manner, the second sliding portion 22 is also prevented from being in contact with the bottom surface of the second guide trench 32 and/or the rear side surface 322 by the second resin member 42.

In the digital camera, not only the first resin member 41 but also various interposing members may be interposed between the front side surface 311 of the first guide trench 31 and the first sliding portion 21. Not only the second resin member 42 but also various interposing members may be interposed between the front side surface 321 of the second guide trench 32 and the second sliding portion 22. Furthermore, as these interposing members, not only a resin material but also a member (easily sliding member), for example, a metal material having a friction coefficient that is smaller than that of the first sliding portion 21 or the second sliding portion 22 when the sliding member is in contact with the first guide trench 31 or the second guide trench 32 may be employed.

The various configurations employed in the digital cameras can also apply to a digital camera in which the slide member 2 slides in a predetermined direction (for example, horizontal directions) along the front surface of the device body 1. The various configurations employed in the digital cameras can be applied to various electronic devices including slide members that slide along the front surfaces of the device bodies.

What is claimed is:

1. An electronic device which includes a device body and in which a sliding member that slides along the surface of the device body is connected to the device body, the sliding member can be moved between a closed position where a predetermined area of a surface of the device body is covered, and an opened position where the predetermined area is exposed, a guide trench that regulates the moving path of the sliding member is concavely formed in the device body, and a sliding portion that is slidingly fitted in the guide trench is formed in the sliding member, wherein an interposing member having a friction coefficient smaller than that of the sliding portion with respect to the guide trench is interposed between the sliding portion and the guide trench, and an engagement mechanism that engages the sliding portion and the interposing member with each other are arranged on the sliding portion and the interposing member.

2. The electric device according to claim 1, wherein, in a direction along the guide trench and a direction that is almost vertical to the direction of the guide trench and in which the the interposing member extends from the bottom surface of the guide trench, the interposing member is prevented from shifting from a predetermined position in the sliding portion.

3. The electronic device according to claim 1, wherein at least the sliding portion is made of metal, at least a part of the device body is made of resin, and the guide trench is formed in the resin portion of the device body.

4. The electronic device according to claim 1, wherein the interposing member is a resin member made of resin.
